(19) United States
(12) Patent Application Publication
(10) Pub. No.: US 2007/0103437 A1
(43) Pub. Date: May 10, 2007

(54) Haptic metering for minimally invasive medical procedures

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/260,000

(22) Filed: Oct. 26, 2005

(51) Int. Cl. G09G 5/08

(52) U.S. Cl. 345/161

(57) ABSTRACT

A method of providing spatially metered haptic sensations to a user includes detecting motion of a surgical instrument within two degrees of freedom; repeatedly determining whether the surgical instrument has moved by an incremental distance in a particular direction with respect to some portion of a patient's body; and imparting a discrete haptic sensation upon a user each time it is determined that the surgical instrument has moved by the incremental distance in a particular direction.

### BACKGROUND OF THE INVENTION

1. Field of the Invention

The present invention relates generally to the generation of haptic tick-mark sensations in conjunction with computer controlled spatial metering parameters. More specifically, the present invention relates to catheter and other flexible instrument procedures in which an elongated flexible medical instrument is inserted into a tubular body organ such as a vein, artery, bronchial tube, urethra, intestine, etc., under the control of a human operator, wherein the elongated flexible instrument is guided along a length of the tubular body organ by the human operator.

2. Discussion of the Related Art

There is an increasing trend toward the use of “minimally-invasive” surgical procedures (i.e., techniques in which medical tools are inserted into a patient's body through a relatively small opening in the body and manipulated from outside the body) that employ flexible elongated medical instruments such as catheters, flexible scopes (e.g., bronchoscopes, and colonoscopes, etc.) and the like (generically referred to herein as “flexible intra-tubular medical instruments”), that are inserted into the open cavity of tubular body organs such as a veins, arteries, bronchial tubes, urethras, intestines, etc., and are usually translated along a length of that tubular cavity.

Such procedures share similar features in that the human operator performing the procedure must insert the flexible intra-tubular medical instrument into a tubular body organ and navigate along the length of that tubular organ to reach a desired destination or destinations. Such navigation is often complex, requiring the medical instrument to be painstakingly fed into the tubular organ by the human operator and guided around bends and folds and into particular branches or bifurcations, to reach a desired destination.

The procedure described above is made more complicated because the human operator generally has limited control over the path taken by the tip of the instrument as it is fed forward, having to carefully adjust the tip shape and tip orientation to get around bends and folds and into particular branches or bifurcations. Often, many attempts are required to get flexible instrument to follow a desired path or to reach a desired location. To further complicate matters, the human operator often has limited visual feedback as he or she guides the flexible intra-tubular medical instrument along the length of tubular body organ, often without stereoscopic depth perception.

To facilitate navigation of the flexible intra-tubular medical instrument, visual imaging techniques have been employed. For example, and as disclosed in US Patent Application 20040097806 which is hereby incorporated by reference, a cardiac catheterization procedure can be performed with the aid of X-ray fluoroscopic images. Two-dimensional fluoroscopic images taken intra-procedurally allow a physician to visualize the location of a flexible catheter being advanced through tubular cardiovascular structures. However, use of such fluoroscopic imaging throughout a procedure exposes both the patient and the operating room staff to excessive amounts of radiation, and exposes the patient to potentially harmful contrast agents. Therefore, the number of fluoroscopic images taken during a procedure must be limited to reduce the radiation exposure to the patient and staff. Because only a limited number of images can be taken, the human operator is under pressure to quickly but safely manipulate the flexible intra-tubular medical instrument to a desired location or position.

In addition to real-time fluoroscopy, new image guided medical and surgical procedures have recently been developed that utilize patient images obtained prior to or during a medical procedure to guide a physician performing the procedure. Recent advances in imaging technology, especially in imaging technologies that produce highly-detailed, computer-generated three dimensional images, such as computed tomography (CT), magnetic resonance imaging (MRI), and ultrasound imaging has increased the interest in image guided medical procedures. An image guided surgical navigation system that enables the physician to see the location of an instrument relative to a patient's anatomy, without the need to acquire real-time fluoroscopic images throughout the surgical procedure is generally disclosed in U.S. Pat. No. 6,470,207, entitled “Navigational Guidance Via Computer-Assisted Fluoroscopic Imaging,” issued Oct. 22, 1202, which is incorporated herein by reference in its entirety. In this system, representations of surgical instruments are overlaid on pre-acquired fluoroscopic images of a patient based on the position of the instruments determined by a tracking sensor.

As disclosed in US Patent Application 20050107688 which is hereby incorporated by reference, methods and systems have been developed for maneuvering a catheter to a desired location within the vessel while providing visual feedback to the physician performing the procedure. For example, a marker band is attached to the catheter close to the forward tip, thereby enabling the physician to navigate the catheter by viewing the marker band in a real-time X-ray image of the vessel. In another case, the physician can view a graphical representation of the position and orientation of the stent on the real-time X-ray image, according to position and orientation data acquired by a medical positioning system (MPS) sensor, attached to the catheter close to the tip. U.S. Pat. No. 5,928,248 issued to Acker and entitled “Guided Deployment of Stents”, is directed to an apparatus for applying a stent in a tubular structure of a patient. The apparatus includes a catheter, a hub, a pressure control device, a balloon, a stent, a probe field transducer, a plurality of external field transducers, a field transmitting and receiving device, a computer, an input device and a cathode ray tube. The probe field transducer is located within the catheter, at a distal end thereof. The external field transducers are located outside of the patient (e.g., connected to the patient-supporting bed). The field transmitting and receiving device is connected to the external field transducers, the probe field transducer and to the computer. The computer is connected to the cathode ray tube and to the input device. A user calibrates the field transmitting and receiving device in an external field of reference, by employing the external field transducers. The field transmitting and receiving device together with the computer, determine the position and orientation of the probe field transducer in the external field of reference. The user views the position and orientation of a representation of the stent which is located within a tubular structure of the patient, on the cathode ray tube.

All of the procedures described above rely on the ability of the human operator to visually discern the position of the flexible intra-tubular medical instrument within the patient. It is possible, however, that the human operator can become visually distracted during the procedure. Accordingly, it would be beneficial to provide an alternative means to the human operator in determining the spatial presence of the flexible intra-tubular medical instrument within the patient.

A number of systems have been developed for providing computer controlled tactile feedback, often referred to as haptic feedback, to a user manipulating a catheter, flexible scope, or other medical instrument that is inserted into a blood vessel or other enclosed body tract such as a portion of the respiratory tract or gastrointestinal tract. Such systems have generally been developed to provide users with tactile sensations attempting to realistically represent how the medical instrument interacts with biological tissue, enabling a user to better perform the procedure. Such systems are generally applicable two different classes of procedures: 1) master-slave surgical procedures, in which a surgeon controls a medical instrument by commanding an intervening robotic mechanism; and 2) surgical simulation applications in which the user is performing the procedure upon a simulated patient.

With respect to prior art hardware and software systems for enabling computer controlled haptic feedback sensation to be conveyed to users as they manipulate catheters and other flexible medical instruments, a number of hardware and software systems have been developed. For example, U.S. Pat. No. 5,821,920 entitled “Control input device for interfacing an elongated flexible object with a computer system” by the present inventor and hereby incorporated by reference, discloses a prior art computer interface device that allows a user to manipulate a catheter, allows a computer to track the changing location and orientation of the catheter as it is manipulated by the user, and allows a computer to command computer controlled tactile feedback to the user. U.S. Pat. No. 5,623,582 which is entitled “Computer interface or control input device for laparoscopic surgical instrument and other elongated mechanical objects ” and also by the present inventor and also hereby incorporated by reference, discloses a prior art computer interface device that allows a user to manipulate a surgical tool, including but not limited to surgical tools comprising a flexible shaft, allows a computer to track the changing location and orientation of the surgical tool as it is manipulated by the user, and allows a computer to command computer controlled tactile feedback to the user. Other systems have been developed, some specifically intended to provide a simulation environment by which a user can practice a desired medical procedure through a computer simulation that looks and feels real. U.S. Pat. No. 6,470,302 which is hereby incorporated by reference discloses a system for surgical simulation that provides realistic feedback to users. U.S. Pat. No. 6,024,576 which is by the present inventor and which is also hereby incorporated by reference, also discloses a hardware and software system for surgical simulation of medical procedures that provides simulated electronically controlled haptic feedback to users intended to represent the real world interactions between a surgical tool and a user's body. As disclosed in this prior art patent, haptic feedback sensation profiles are generated that realistically represent the interaction between a surgical instrument and a patient's body.

In master-slave surgical procedures, the user manipulates a user interface (referred to as a master), that interfaces with a computer system that controls a robotically controlled surgical instrument (referred to as a slave) which, in turn, interacts with the body of a patient in accordance with the user's manipulation of the master. To facilitate user control of the slave through the master, the user is sometimes provided with electronically controlled tactile feedback through the master, the tactile feedback presenting the user with realistic indications of how the real surgical instrument portion of the slave interacts with the body of the patient. In this way the user can control a real surgical instrument through an intervening robotic system by manipulating a master and can feel the interactions between the surgical instrument and the body of the patient even through the user is not directly manipulating the surgical instrument. For example, U.S. Pat. No. 6,096,004 entitled “Master/slave system for the manipulation of tubular medical tools” and which is hereby incorporated by reference, discloses a master/slave system for catheter based medical procedures that provides tactile feedback to the user.

As disclosed in U.S. Pat. No. 6,096,004, it is known in the art use master/slave control systems for some types of minimally-invasive medical procedures. Master/ slave control systems are generally configured with a control that can be manipulated by a user, an actuator that holds a tool used in the procedure, and an electromechanical interface between the control and the tool. The electromechanical interface causes the tool to move in a manner dictated by the user's manipulation of the control. An example of a medical use of master/slave systems is in conjunction with an exploratory procedure known as “laparoscopy”. During laparoscopy, a physician manipulates a control on a master device in order to maneuver an elongated camera-like device known as a “laparoscope” within the abdominal cavity. The movement of the laparoscope is actually effected by a slave device in response to signals from the master device that reflect the movement of the control by the physician. During the procedure, the physician receives visual feedback directly from the laparoscope. In addition to serving the diagnostic purpose of enabling the physician to examine the abdominal cavity, the visual feedback also enables the physician to properly maneuver the laparoscope.

Master/slave systems provide benefits that the direct manipulation of a surgical tool by a physician does not. Sometimes it is beneficial for the physician and patient to be physically isolated from each other, for example to reduce the risk of infection. A master/slave system may provide greater dexterity in the manipulation of small tools. Also, a master/slave system can be programmed to provide effects not achievable by a human hand. One example is force or position scaling, in which subtle movements on one end either cause or result from larger movements on the other end. Scaling is used to adjust the sensitivity of tool movement to movement of the control. Another example is filtering, such as filtering to diminish the effects of hand tremor or to prevent inadvertent large movements that might damage tissue.

In contrast to procedures such as laparoscopy in which the medical tool provides visual feedback, other minimally invasive procedures rely more heavily on other forms of feedback to enable a physician to maneuver a medical tool. For example, imaging apparatus is used in conjunction with balloon angioplasty to enable the physician to track the location of the end of the catheter or wire as it is threaded into an artery. This is also the case in interventional radiology. Master/slave systems developed to support such procedures provide haptic feedback such that the physician can feel the resistance experienced by the slave catheter as it is being moved along the wall of an artery. Such haptic feedback is an important component of the sensory information used by the physician to successfully carry out these types of procedures and is therefore a valuable feedback means within the master/slave system. Such feedback is similarly important in bronchosopy, colonoscopy, and other flexible instrument based procedures.

Because procedures such as the minimally-invasive medical procedures described above require substantial manual dexterity, are often performed under time pressure, and are often performed with limited visual feedback, it would be beneficial to provide a haptic metering method and apparatus adapted to increase an operators' situational awareness as they guide a flexible medical instrument along the length of a tubular body organ.

### SUMMARY OF THE INVENTION

Several embodiments of the invention advantageously address the needs above as well as other needs by providing a system and method of providing haptic metering. In one embodiment, the invention can be characterized as a method of providing spatially metered haptic sensations to a user that includes detecting motion of a surgical instrument within two degrees of freedom; repeatedly determining whether the surgical instrument has moved by an incremental distance in a particular direction with respect to some portion of a patient's body; and imparting a discrete haptic sensation upon a user each time it is determined that the surgical instrument has moved by the incremental distance in a particular direction.

In another embodiment, the invention can be characterized as a method of providing spatially metered haptic sensations to a user that includes defining a plurality of simulated spacing markers with an incremental distance between them; detecting motion of an elongated flexible object; repeatedly determining whether the elongated flexible object has moved past a simulated spacing marker; and imparting a discrete haptic sensation upon a user each time it is determined that the elongated flexible object has moved past a simulated spacing marker in a particular direction.

In a further embodiment, the invention may be characterized as a haptic metering system that includes at least one input transducer adapted to detect motion of a surgical instrument within at least two degrees of freedom and output a signal corresponding to the detected motion, the surgical instrument adapted to be moved at least linearly and rotatably under control of a user; control electronics adapted to receive the signal output by the at least one input transducer, repeatedly determine whether the surgical instrument has moved by a defined incremental distance in a particular direction with respect to a reference, and output a control signal each time it is determined that the surgical instrument has moved by the defined incremental distance in the particular direction; and an output transducer adapted to receive the control signals and impart a discrete haptic sensation upon the user based upon each of the received control signals.

In yet another embodiment, the invention may be characterized as a haptic metering system that includes at least one input transducer adapted to detect linear motion of an elongated flexible object and output a signal corresponding to the detected linear motion, the elongated flexible object adapted to be moved under control of a user; control electronics adapted to receive the signals output by the at least one input transducer, repeatedly determine whether the elongated flexible object has moved in a particular direction past one of a plurality of simulated spacing markers, and output a control signal when it is determined that the object has moved past a simulated spacing marker; and an output transducer adapted to receive the control signals and impart a discrete haptic tick-mark sensation upon the user based on each of the received control signals.

In some embodiments a differently feeling discrete haptic sensation is imparted when the object moves in a forward direction past a simulated spacing marker as compared to the discrete haptic sensation imparted when the object moves in a backwards direction past a simulated spacing marker.

In some embodiments a differently feeling discrete haptic sensation is imparted when the object moves past a first type of simulated spacing marker as compared to the discrete haptic sensation imparted when the object moves past a type of second simulated spacing marker, said first type and second type of simulated spacing markers being included in said plurality of simulated spacing markers.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 schematically illustrates an exemplary apparatus for catheterization of cardiac or peripheral vasculature including a set of concentric catheters.

FIG. 2 illustrates an exemplary user interface system adapted to track the location of an object as it is linearly translated and/or rotated, and further adapted to provide electronically controlled haptic sensations.

FIG. 3 illustrate an apparatus for tracking the motion of an elongated flexible medical instrument capable of translation and rotation and for providing haptic feedback in accordance with one embodiment.

FIGS. 4A and 4B illustrate the actuator and transducer, respectively, as shown in FIG. 3 in accordance with one exemplary embodiment of the present invention.

FIG. 5 schematically illustrates a master/slave catheterization system capable of tracking the motion of a master as imparted by a user and capable of providing haptic feedback to the user through the master.

FIG. 6A schematically illustrates a set of translational haptic tick mark sensations in accordance with one exemplary embodiment of the present invention.

FIG. 6B schematically illustrates a set of rotational haptic tick mark sensations in accordance with one exemplary embodiment of the present invention.

FIG. 7 illustrates a fluoroscopic image as would be presented to an operator during an image guided catheter based medical procedure or other flexible elongated medical instrument procedure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Generally, numerous embodiments of the present invention are directed to introducing haptic sensations with computer controlled spatial metering parameters into user interactions with flexible intra-tubular medical instruments such that a user can better perform insertions, retractions, and/or rotations of the flexible instrument as it traverses, for example, a tubular body organ. Exemplary methods and apparatus described herein are applicable to master slave surgical procedures involving substantially any method and/or apparatus, surgical simulation applications, and any other haptic sensations that may be used to provide realistic tool-body interaction feedback. Embodiments of the present invention can be used in traditional surgical procedures (e.g., non-master-slave surgical or simulated surgical procedures) to provide additional situational awareness to the user of a flexible intra-tubular medical instrument. In what are referred to herein as “augmented surgical procedures”, the doctor can manipulate the medical instrument directly (not through a master/slave system) and can be provided with supplemental computer controlled tick-mark sensations in addition to the feedback he or she feels as a result of the interaction between the instrument and the patients body.

According to numerous embodiments disclosed herein, a haptic feedback method and apparatus can be provided that supplies information that is more than just a direct realistic representation or a scaled realistic representation of how a slave instrument physically interacts with the patients body. Rather, the various embodiments disclosed herein introduce spatially metered haptic sensations that provide additional informative information to the doctor that enables the doctor to perform with greater dexterity and confidence as he or she maneuvers a flexible instrument within a vessel or tract of a patient's body. For example, embodiments of the present invention describe haptic metering sensations, which are haptic sensations based upon the incremental displacement and/or incremental rotation of the real surgical instrument with respect to the enclosed vessel or tract of the patients body within which it is moving. Haptic metering sensations provide the operator with haptic cues related to linear and rotary motion of the surgical instrument relative to the vessel or tract within which it is moving. Accordingly, the haptic metering sensations are not a representation of the real physical forces present in the interaction between the real surgical tool and the real body of the user and are thus highly informative and allow the operator to perform with increased awareness, confidence, and dexterity.

Where embodiments of the present invention are implemented in conjunction with master-slave applications that involve position scaling (i.e., modified master to slave position control mapping such that larger motions of the master result in smaller motions of the slave to give operators enhanced dexterity), haptic metering sensations can be presented to the user at the master to indicate motion of the master of a first incremental spacing wherein such motion of the master results in motion of the slave with a smaller second incremental spacing. Accordingly, haptic metering sensations generated in accordance with various embodiments of the present invention can be employed in master slave systems that provide amplified user dexterity with metering feedback. For example, a user may haptic metering sensations (e.g., tick marks) with a spacing of millimeters as he or she manipulates a master and thereby controls a slave to perform incremental motions that are micrometers.

Where embodiments of the present invention are implemented in conjunction with augmented surgical procedures applications, the user manipulates the surgical tool directly (not through a master) as he or she would through traditional performance of the surgical procedure, the surgical instrument interacting directly with the patients body as a result of the user's manipulations while also being provided with computer controlled haptic sensations. The computer controlled haptic sensations are imparted upon the user in addition to the direct haptic sensations felt by the user as a result of the surgical instruments interactions with the patient's body. As will be discussed in greater detail below, additional actuators are included upon the flexible elongated medical instrument that can impart supplemental haptic sensations on the surgical instrument or on the user directly such that the user will feel these sensations in addition to other sensations he or she feels while manipulating the surgical instrument.

In some embodiments, augmented surgical procedures may be performed in conjunction with the use of display technology to show the operator the location of the flexible surgical instrument within the tubular body organ.

For example, an augmented surgical procedure used in conjunction with X-ray fluoroscopy increases the speed at which the user performs the surgical procedure, reduces the time required for the procedure, and/or reduces the number of fluoroscopic images that need to be taken during the procedure. Because haptic metering sensations provide the user with touch-based situational awareness as to the progress of the flexible elongated medical instrument within the tubular body organ, the user has a better sense of tool location—aside and apart from updated fluoroscopic images. In one embodiment, the visual display presented to the user can be enhanced with visual demarcations corresponding to the haptic tick mark sensations. For example a visual grid and or a visual display of lines or dots representing the spacing and location of tick marks can be presented upon the fluoroscopic image display, the visual grid or lines or marks corresponding with the haptic tick marks felt by the user. In this way the user has further enhanced situational awareness as he or she manipulates the surgical instrument, feeling tick marks manually and relating them to the visual marks displayed upon the fluoroscopic image.

In another example, an augmented surgical procedure used in conjunction with image guided surgical navigation systems such as those described above, wherein signals from the tracking sensor or a medical positioning system (MPS) sensor, as accessed by control electronics disclosed in greater detail below, can be used to measure and/or determine the incremental motion of the flexible elongated medical instrument and trigger appropriate tick mark sensations accordingly.

As used herein, the term “haptic metering” refers to the provision of haptic sensations (also known as force feedback sensations or tactile sensations) to a human operator as he or she manipulates an elongated flexible medical instrument within a tubular body organ. In one embodiment, haptic sensations can be generated by an electronically-controlled haptic feedback actuator in accordance with an incremental translation and/or incremental rotation of the elongated flexible instrument with respect to a fixed reference point. In one embodiment, the haptic sensations are provided to the user of an elongated flexible medical instrument through the generation and presentation of simulated haptic tick-mark sensations, wherein the haptic tick-mark sensations can be characterized as a set of quick jolts or short duration vibrations that are spatially metered. As used herein, the set of quick jolts or short duration vibrations are “spatially metered” in that tick sensations in the set are spatially separated from each other by an incremental distance such that each is sequentially engaged by the user as he or she moves the elongated flexible medical instrument across the incremental distances. Accordingly, haptic metering introduces an artificial array of haptic sensations into the user interface such that simulated tick-mark sensations are electronically generated and imparted upon the user as the elongated flexible medical instrument is inserted, retracted, and/or rotated a particular incremental distance by a user, wherein each simulated tick-mark sensation is generated and imparted based upon the traversal of an incremental insertion, retraction, and/or rotation distance. Using the haptic metering described herein, the user will be provided with a set simulated electronically generated tick mark sensations, wherein each tick mark sensation in the set is sequentially generated and imparted to the user as the flexible elongated medical instrument is inserted forward by each of a series of repeated incremental steps.

In some embodiments of the present invention the spacing of the simulated tick-mark sensations can be configured in electrics and/or software to be of a plurality of different spacing values, the spacing values being the incremental distance that must be traversed by the flexible medical instrument with respect to the reference point between the generation of subsequent physical tick mark sensation by the electronically controlled actuator. In some embodiments a plurality of different “tick” sensations are enabled by control electronics and/or software, the plurality of different tick marks having distinguishable feel by a human operator. For example, “tick” sensations may have varying feel qualities such as varying magnitude and duration. In some embodiments, a repeated sequence or pattern of tick sensations of varying quality are generated under electronic control, the sequence or pattern of tick sensations comprised a user-distinguishable plurality of tick sensations of varying quality arranged in repeating pattern that is easily recognized by the user to further facilitate situational awareness. For example, two types of tick sensations may be provided to the user as the user inserts or retracts a catheter into a vascular organ. A first type of tick sensation is of a moderate magnitude and is presented every time the catheter is traversed a certain incremental distance (×) in a particular direction, the second type of tick is of a stronger magnitude and is presented every time the catheter is traversed by a multiple of five of the incremental distance (5×). In this way the user feels a particular first tick sensation as he or she moves the catheter forward or backward by the certain incremental distance (×), except when the catheter moves forward or backwards by a multiple of five of the certain incremental distance (5×), then the user feels a second stronger tactile sensation. In this way the user not only knows when he or she has moved the catheter forward or backward by the certain incremental distance (×), he or she also knows when he or she has moved the catheter forward by an absolute amount equal to a multiple of five of the incremental distance. This provides both fine and course levels of situational awareness, for the first type of haptic tick-mark sensation serves as a fine positioning feedback stimulus and the second type of haptic tick-mark sensation serves as a course positioning feedback stimulus. In this way the computer generated haptic tick-mark sensations that are dependent upon incremental motion of the flexible medical instrument increases the user's sense of the position and motion of the medical instrument with respect to a fixed reference point. In some embodiments more than two types of haptic tick mark sensations are generated and imparted under electronic control, each of the more than two types of haptic tick mark sensation being distinguishable by feel by a user and presented in a repeated pattern to help provide situational awareness to the user, providing additional information about his or her induced motion of the flexible elongated medical instrument.

Another feature of the present invention is that different of the tick mark sensations may be assigned to different directions of motion of the flexible medical instrument. For example, different and distinguishable tick mark sensations may be assigned to forward motion of the flexible medical instrument into the tubular organ as compared to the tick sensations assigned for backward motion of the flexible medical instrument. Similarly, different and distinguishable tick sensations may be assigned to incremental rotation of the flexible medical instrument within the tubular organ as compared to incremental translation of the flexible medical instrument. In addition, a user interface is provided that allows the operator to change the parameters of the tick sensations, for example the incremental distance, during a procedure. In this way the user can select coarsely spaced incremental tick sensations when doing course positioning of the flexible medical instrument and can select finely spaced incremental tick sensations when performing fine positioning of the flexible medical instrument. In addition the invention allows for different incremental distances to be set for insertion as compared to retraction. This is because insertion of the flexible medical instrument deeper into the tubular organ is often performed more slowly and carefully than retraction of the flexible medical instrument out of the tubular organ. Similarly, the invention allows for incremental spacing values that define the spacing of ticks to be set in linear distances such as millimeters for traversal along the tubular organ and be set in angular distances such as degrees for rotation of the flexible medical instrument within the tubular organ. In addition the present invention allows the quality of the simulated feel of the tick sensations to be dependent upon velocity of motion of the flexible medical instrument.

In accordance with numerous embodiments of the present invention allow the user to selectively add, remove, and/or modify the haptic tick mark sensations. By interacting with a user interface, the user interface being graphically displayed to the user or presented through a set of physical controls such as knobs and buttons, the user is enabled by the present invention to configure the tick mark sensations that are presented under electronic control when the user manipulates the flexible elongated medical instrument. In some embodiments the user can selectively adjust the spacing between tick marks by modifying the spacing value used by the electronics and/or software to generate the tick mark sensations. In some embodiments the user can selectively adjust the magnitude (i.e. force intensity) of the tick mark sensations, selecting among a range of available magnitudes. In this way a user can configure the tick mark sensations to the level he or she prefers. Also the user can adjust the magnitude during a procedure. For example, if the user wants to carefully feel how the flexible medical instrument is interacting with body tissue under his or her control, the user may choose to turn down the magnitude of the overlaid haptic tick mark sensations such that they do not mask the real-world feedback coming from patient interactions. In some embodiments the user can selectively turn on and turn off the haptic tick mark sensations, allowing the user to selectively manipulate the medical instrument with and without the added tick mark sensations. In some embodiments the user can adjust the form of individual tick mark sensations, not just adjusting the magnitude, but also adjusting the duration and/or other time-varying parameters as a means of achieving a desired feel. Also, in some embodiments of the present invention the user can adjust the pattern of tick mark sensations when a plurality of distinct and distinguishable medical instrument are employed to, for example, selectively deploy primary and secondary tick mark sensations.

Finally, in master-slave surgical procedure applications that involve position scaling (i.e., modified master to slave position control mapping such that larger motions of the master result in smaller motions of the slave to give operators enhanced dexterity), the present invention of haptic metering can be inventively applied with particular benefit for the simulated tick marks presented to the user at the master to indicate motion of the master of a first incremental spacing wherein such motion of the master results in motion of the slave with a much smaller second incremental spacing. In this way, haptic metering tick marks of the present invention can be employed in master slave systems that provide amplified user dexterity. For example, a user may feel tick marks with a spacing of millimeters while controlling a slave to perform incremental motions that are micrometers.

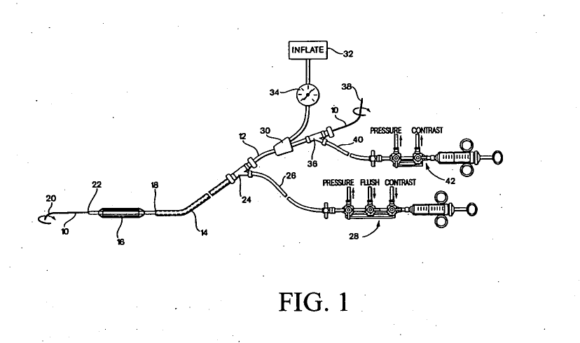

FIG. 1 illustrates an exemplary apparatus, similar to that disclosed in U.S. Pat. No. 6,096,004, in which a haptic metering system of one embodiment of the present invention may be used.

Referring to FIG. 1, the apparatus includes an inner wire 10, a tubular balloon catheter 12, and a tubular guide catheter 14. The balloon catheter 12 includes a dilatation balloon 16 at one end that extends beyond a corresponding end 18 of the guide catheter 14. The wire 10 has a tip 20 that extends beyond the end 22 of the balloon catheter 12.

A first Y adaptor 24 is secured to the guide catheter 14. The balloon catheter 12 extends through one leg of the Y adaptor 24, and tubing 26 is attached to the other leg. The tubing 26 carries contrast and other solutions into the guide catheter 14. The contrast solution enhances the visibility of the vessel being catheterized on imaging equipment used during the catheterization, process, enabling the doctor to better guide the catheter. The injection and flushing of the contrast and other solutions is controlled by apparatus 28 as is known in the art.

A coupling 30 enables the attachment of an inflation device 32 and associated pressure meter 34, as well as a second Y adaptor 36. A user end 38 of the wire 10 extends from one leg of the Y adaptor 36, and tubing 40 extends from the other leg. The tubing 40 is connected to contrast injection and flushing apparatus 42 used to provide contrast and other solutions to the balloon catheter 12.

As shown in FIG. 1, the ends 20 and 38 of the wire 10 are bent slightly. At the user end 38, the bent section enables the wire 10 to be rotated about its longitudinal axis (also referred to herein as “axial rotation”) by a doctor. At the inner or guide end 20, the bent section enables the wire 10 to be steered through turns and branches in the pathway to the vessel being catheterized.

During a balloon angioplasty procedure for a cardiac artery, the guide catheter 14 is first inserted into the femoral artery of a patient so that its end is at the aortic arch, near the opening of a cardiac artery to be operated upon. The guide catheter 14 arrives at this position by being slid along a previously-inserted guide wire (not shown), which is removed after the guide catheter 14 is in place. Next, the balloon catheter 12 and wire 10 together are pushed through the guide catheter 14 to its end. The wire 10 is then manipulated into the artery to the area to be dilated, and the balloon 16 is pushed along the wire 10 into the desired position. In this position the balloon 16 is inflated as necessary to achieve the desired dilation of the artery.

This figure is presented as an example minimally invasive medical procedure wherein a human operator manipulates a flexible elongated medical instrument. In this case, as is true of many procedures, the medical instrument includes a plurality of flexible elongated instrument components, each of which may have haptic metering sensations applied to it in accordance with the present invention. In this case wire 10 is an inner flexible elongated medical instrument component whose location and orientation can be sensed such that its incremental motion can be detected and which can be acted upon by a haptic actuator such that user manipulating the flexible elongated medical instrument component will feel haptic metering sensations in accordance with the present invention. As described herein, the haptic metering sensations can be imparted upon the user through the flexible elongated medical instrument component or through other physical contact with the user. As described herein the haptic metering sensations are generated by the haptic actuator under the control of control electronics and/or control software that imparts tick-mark sensations as described herein in response to the sensing of the location and/or orientation of the flexible elongated medical instrument component. Also shown in this figure is guide catheter 14 which is also a flexible elongated medical instrument component whose location and orientation can be sensed such that its incremental motion can be detected and which can be acted upon by a haptic actuator such that user manipulating the flexible elongated medical instrument component will feel haptic metering sensations in accordance with the present invention. In this case the guide catheter 14 is an outer flexible elongated medical instrument component that houses the inner flexible elongated medical instrument component. As described herein, the haptic metering sensations can be imparted upon the user through the flexible elongated medical instrument component or through other physical contact with the user. As described herein the haptic metering sensations are generated by the haptic actuator under the control of control electronics and/or control software that imparts tick-mark sensations as described herein in response to the sensing of the location and/or orientation of the flexible elongated medical instrument component. The haptic metering sensations felt by the user can be independently imparted for each of the plurality of flexible elongated medical instrument components or in some embodiments may be jointly imparted for both. Similarly the sensor tracking of the position and/or orientation of the flexible elongated medical instrument components may be made performed independently for each component, or jointly. If jointly sensor tracked, the position and/or orientation measure of one elongated flexible component may be made relative to other elongated flexible components. In one embodiment, the sensor tracking of the flexible elongated medical instrument components produces absolute values, relative values, or a combination thereof.

With respect to methods and apparatus for tracking the position and/or orientation as relative or absolute values of the one or more flexible elongated medical instrument components and with respect to methods and apparatus for providing haptic feedback to the user who is manipulating the flexible elongated medical instrument components, a variety of hardware and software methods may be employed.

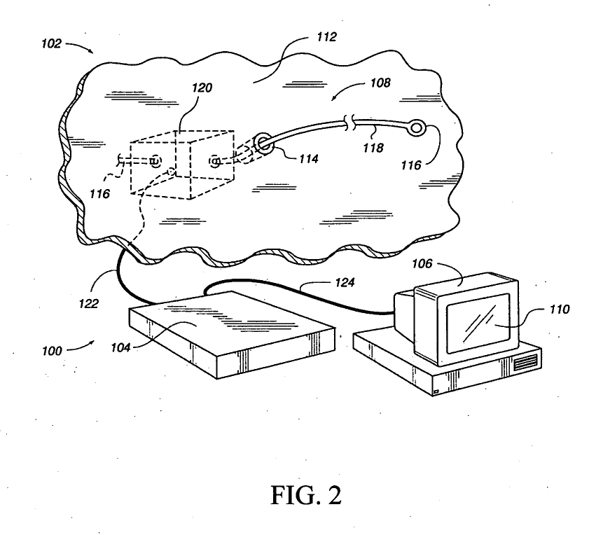

FIG. 2 illustrates an exemplary user interface system adapted to track the location of an object as it is linearly translated and/or rotated, and further adapted to provide electronically controlled haptic sensations.

Referring to FIG. 2, a user interface system 100 includes flexible elongated medical instrument feedback apparatus 102 (herein generically referred to as the “apparatus”), an electronic interface 104, and a computer 106. The apparatus 102 further includes a sensing and feedback transducer mechanism 120 coupled to the electronic interface 104 by a cable 122 and coupled to the computer 106 by a cable 124.

A catheter 108 used in conjunction with the present invention is manipulated by an operator. The catheter 108 could be a master in a master-slave robotic surgical system or could be a catheter used directly to perform a medical procedure, as shown in the exemplary embodiment of FIG. 1. In the present embodiment, the catheter 108 is fed into a patient and is used directly to perform a desired medical procedure, wherein the system further includes a barrier 112 and a “central line” 114 through which the catheter is inserted into the body of the patient. The barrier 112 is generally a portion of the skin covering the body of a patient. Central line 114 is inserted into the body of the patient to provide an entry and removal point from the body of the patient for the catheter 108, and to allow the manipulation of the distal portion of the catheter 108 within the body of the patient while minimizing tissue damage. Catheter 108 and central line 114 are commercially available from sources such as Target Therapeutics of Fremont, Calif., USA and U.S. Surgical of Connecticut, USA.

As illustrated, the catheter 108 includes a handle or “grip” portion 116 and a shaft portion 118. The grip portion 116 can be any conventional device used to manipulate the catheter or may comprise the shaft portion 118 itself. The shaft portion 118 is an elongated flexible object and, in particular, is an elongated cylindrical object.

The electronic interface 104 and couples the apparatus 102 to the computer 106. Although the computer 106 is presently illustrated as a separate component, it will be readily appreciated that the computer 106 can also be an integral part of the electronic interface 104. In some embodiments, the electronic interface 104 interfaces with the various actuators and sensors contained within the apparatus 102 to the computer 106, wherein the computer 106 performs control algorithms that produce haptic metering sensations.

In one embodiment the computer 106 also displays a user interface (e.g., via a user display 110) which a user can use to selectively configure the parameters of the haptic tick-mark sensations employed in the haptic metering technique. For example, the user interface allows the user to adjust the incremental distance between tick mark sensations that to are felt by the user during a procedure. In this way the user can select coarsely spaced incremental tick sensations when doing course positioning of the flexible medical instrument and can select finely spaced incremental tick sensations when performing fine positioning of the flexible medical instrument. In some embodiments, the user interface allows for different incremental distances to be set for insertion as compared to retraction. This is because insertion of the flexible medical instrument deeper into the tubular organ is often performed more slowly and carefully than retraction of the flexible medical instrument out of the tubular organ. In some embodiments, the user interface allows for the incremental spacing values that define the spacing between haptic tick mark sensations to be set in real-world linear distances such as millimeters of traversal along the tubular organ and be set in real-world angular distances such as the number of degrees for rotation of the flexible medical instrument within the tubular organ. In some embodiments, the user interface allows for the user to adjust the quality of the simulated feel of the tick sensations and/or to selectively add, remove, and/or modify the haptic tick mark sensations at various times during a procedure. By interacting with the user interface, the user interface being graphically displayed to the user on the computer 106 and/or enabled through a set of physical controls such as knobs and buttons interfaced to the computer 106, the user is enabled by the present invention to configure the tick mark sensations that are presented under electronic control when the user manipulates the flexible elongated medical instrument. In some embodiments the user can selectively adjust the spacing between tick marks by modifying the spacing value used by the electronics and/or software to generate the tick mark sensations. In some embodiments the user can selectively adjust the magnitude (i.e. force intensity) of the tick mark sensations, selecting among a range of available magnitudes. In this way a user can configure the tick mark sensations to the level he or she prefers. In many one embodiments the user can adjust the form of individual tick mark sensations, not just adjusting the magnitude, but also adjusting the duration and/or other time-varying parameters as a means of achieving a desired feel. Also, in many one embodiments of the present invention the user can adjust the pattern of tick mark sensations when a plurality of distinct and distinguishable are employed, for example selectively deploying primary and secondary tick mark sensations with user defined spacing there between.

In one embodiment, the electronic interface 104 may be provided as described, for example, in U.S. Pat. No. 5,734,373 which is by the present inventor and which is hereby incorporated by reference in its entirety. Furthermore, additional methods by which electronic interface 104 can control the shape and or form of individual haptic sensations is described in U.S. Pat. No. 5,959,613 by the present inventor and which is also incorporated herein by reference in its entirety.

While the present description has been discussed with reference to the shaft portion 118 of a catheter tool 108, it will be appreciated that other similar elongated flexible medical instruments (or components thereof can be used with the flexible elongated medical instrument feedback apparatus 120.

Generally, the sensing and feedback transducer mechanism 120 tracks movement of the shaft portion 118 as it is fed into the body, retracted from the body, and/or rotated within the body. Because minimally invasive procedures typically involve insertion into a tubular body organ, movement of the shaft portion 118 is constrained to motion in only two degrees freedom (i.e., linear translation into and out of the tubular organ and rotary rotation about the axis of the shaft portion 118).

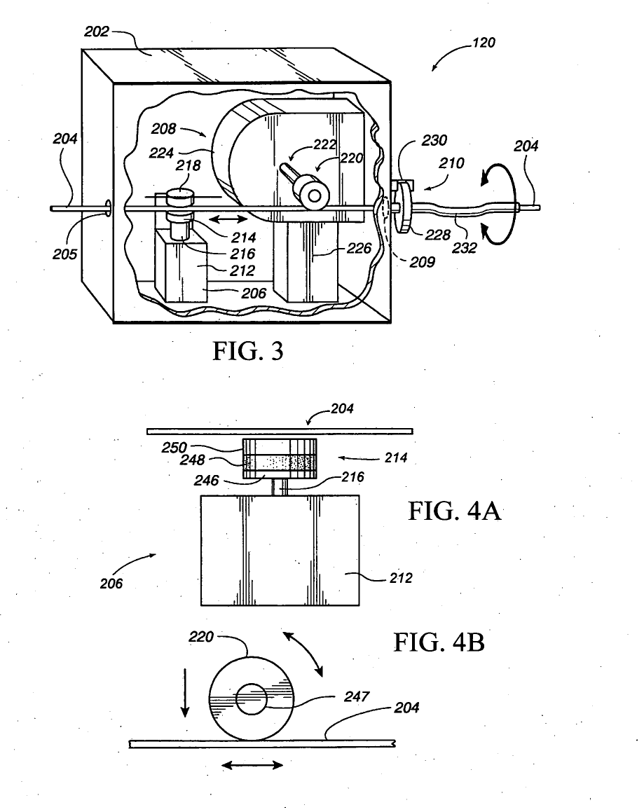

FIG. 3 illustrates the sensing and feedback transducer mechanism shown in FIG. 2, in accordance with one exemplary embodiment of the present invention.

Referring to FIG. 3, sensing and feedback transducer mechanism 120 includes an object receiving portion 202, a first aperture 205, one or more transducers (e.g., an actuator 206, a translation transducer 208, and a rotational transducer 210) associated with an elongated flexible object 204, and a second aperture 209. As used herein, the terms “associated with”, “related to”, and the like, are indicate that the electromechanical transducer is either influenced by, or influences one of the degrees of freedom of the elongated flexible object 204. Further, and as exemplary illustrated, the actuator 206 is provided as a voice coil comprising a base portion 212 coupled to a striking portion 214 via a shaft 216, wherein the base portion 212 is coupled to the object receiving portion 202. As also exemplary illustrated, the translation transducer 208 includes a wheel 220 which wheel is mounted on a shaft 222 coupled to a translation sensor 224, wherein the translation sensor 224 is coupled to object receiving portion 202 by a base 226. Finally, the rotational transducer 210 includes, for example, a disk 228, a rotation sensor 230, and a hollow shaft 232.

The elongated flexible object 204 (e.g., a catheter or other flexible elongated medical instrument) is introduced into the object receiving portion 202 via the first aperture 205, passes through the interior of the object receiving portion 202, exits the second aperture 209, and passes through the rotational transducer 210 before it enters the patient's body.

In one embodiment, the object receiving portion 202 is fashioned from a unitary mass of material made from plastic or some other lightweight material. The object receiving portion 202 can also be a housing to which the various transducers are coupled.

According to numerous embodiments of the present invention, the transducers can be input transducers, output transducers, or bidirectional transducers.

Input transducers (also referred to as sensors) sense motion along a respective degree of freedom and produce a corresponding electrical signal for input into electronic interface 104 and/or computer 106. The input transducers can be configured to sense absolute motion (e.g., both linear and rotary) of the elongated flexible object 204, relative motion of the elongated flexible object 204, or both relative and absolute motion of the elongated flexible object 204. In one embodiment, an input transducer can be provided as an encoded wheel transducer, a potentiometer, an optical encoder, a CCD camera, a vision system, a magnetic sensor, an ultrasonic sensor, a radio frequency sensor, an emitter detector pair, and the like, or combinations thereof. In some embodiments, the input transducers may require a calibration step after system power-up, wherein the elongated flexible object 204 is placed in a known position/orientation and a calibration signal is provided to the electronic interface 104 based on movement of the elongated flexible object 204 away from the known position/orientation. Such calibration methods are known to the art and, therefore, need not be discussed in great detail.

Output transducers (also referred to as actuators or haptic actuators) receive electrical signals from electronic interface 104 and/or computer 106 and impart a physical force on the elongated flexible object 204 in accordance with their respective degrees of freedom. In one embodiment, a single output transducer produces haptic metering sensations associated with motion of the flexible elongated object 204 in a single degree of freedom. In another embodiment, a single output transducer produces haptic metering sensations associated with motion of the flexible elongated object 204 in a plurality of degrees of freedom. For example, a single output transducer may be used to produce haptic metering sensations associated with linear translation of the elongated flexible object 204 by the operator by an incremental distance and/or may also be used to produce haptic metering sensations associated with rotary rotation of the elongated flexible object 204 by the operator by an incremental angle. In one embodiment, an output transducer can be provided as an active actuator (e.g., an electromechanical or electromagnetic actuator, stepper motor, a servo motor, a pneumatic actuator, a hydraulic actuator, a piezoelectric actuator, a electro-active polymer actuator, a shape memory alloy actuator, voice coil, electro-active polymer actuator, solenoid, etc.), adapted to impart an active force to the elongated flexible object 204, or a passive actuator (e.g., a magnetic particle brake, a friction brake, etc.), adapted to impart a fixed or variable frictionally resistive force on the elongated flexible object 204, or combinations thereof. As used herein, the term “active force” refers to an impulse or vibration imparted by an output transducer that is transmitted to, and felt by the user along the elongated flexible object 204 but that does not impart linear motion onto the flexible elongated object 204 (e.g., into or out of a tubular organ) and does not impart a rotary motion of the flexible elongated object 204 around its axis. In one embodiment, the output transducers have a response time suitable for short and crisp tick mark sensations (i.e., a fast response time), a low cost and low complexity.

Generally, bi-directional transducers (also referred to as hybrid transducers) operate both input and output transducers. In one embodiment, a bidirectional transducer can be provided as a pair of input and output transducers, as a purely bi-directional transducer such as a permanent magnet electric motor/generator, and the like, or combinations thereof.

The actuator 206 is adapted to impart haptic sensations to the elongated flexible object 204. For example, the striking portion 214 rapidly engages elongated flexible object 204 (e.g., by briefly striking the object, by pressing upon the object with a changing periodic vibrating force, etc.) to apply a quick impulse force. The impulse force or periodic vibration force is applied by 214 in a direction substantially perpendicular to the direction of translation of the elongated flexible object 204, which direction is indicated by the linear bidirectional arrow, to producing a sensation that is transmitted along the wire and felt by the user who is manually manipulating the object 204. It will be appreciated that other actuator devices may be employed in the invention, e.g., especially actuators that can impart a high bandwidth impulse or vibration upon the object 204 such a high performance linear electric motor, an inertial mass actuator, a piezo-electric actuator, a pneumatic or hydraulic device, electro-active polymer device, or the like, which applies the striking force or vibratory force to elongated flexible object 204.

FIG. 4A illustrates the actuator shown in FIG. 3, in accordance with an exemplary embodiment of the present invention.

Referring to FIG. 4A, the actuator 206 is provided as a voice coil 206 including a base portion 212 that is coupled to a striking portion 214 through a reciprocating shaft 216. Striking portion 214 comprises a platform 246 which is coupled with shaft 216 and upon which platform is coupled an optional resilient pad 246 and hard low-friction contact surface 250. Resilient pad 248 comprises a substance which effective to act as a shock absorber, such as rubber, and is optional, to limit over-loading of the object 204 by the striking portion 214 that could result in binding of the object.

Contact surface 250 comprises a substance which is hard and low friction and thereby effective to impart a crisp impulse upon elongated flexible object 204 without inducing lateral friction or rotary friction that might act to stop or slow the translational motion and/or rotational motion of elongated flexible object 204 when the striking portion 214 engages the elongated flexible object 204. The materials appropriate contact surface 250 pad can be a hard smooth metal such as polished stainless steel or a polished diamond coated surface. Voice coil actuator may be replaced by other high bandwidth actuators. In some embodiments a solid state piezoelectric actuator is one. In other embodiments a vibratory shaker is used to induce the striking portion to impart a striking force or vibration upon the object, the vibratory shaker comprising an inertial mass that is rotated eccentrically or an inertial mass that is oscillated linearly.

Referring back to FIG. 3, the translation transducer 208 is adapted to determine translational motion of elongated flexible object 204 by sensing the position of the elongated flexible object 204 along the direction of translation thereof and producing electrical signals corresponding to the sensed positions. In one embodiment, the translation transducer 208 may additionally or alternatively be provided as an output transducer (i.e., an actuator) and apply an impulse force or vibration force to elongated flexible object 204.

FIG. 4B illustrates the linear transducer shown in FIG. 3, in accordance with an exemplary embodiment of the present invention.

As shown in FIG. 4B, the wheel 220 engages elongated flexible object 204 with a normal force (downward arrow) such that translation of elongated flexible object 204 (indicated by the bidirectional linear arrow) causes rotation of shaft end 247 (indicated by the bidirectional curved arrow) creating an electrical signal from translation sensor 224 (not shown) which is recorded by interface 104 (also not shown).

Referring back to FIG. 3, the rotational transducer 210 is rotatably coupled to the object receiving portion 202 and is adapted to determine the rotational motion of elongated flexible object 204. In one embodiment, the disk 228 and hollow shaft 232 are attached together (e.g., by gluing or press fitting) to provide a substantially unitary device. The disk 228 includes an aperture (not shown) dimensioned to receive the elongated flexible object 204 and the hollow shaft 232 is dimensioned to receivably engage the elongated flexible object such that disk 228 substantially tracks the rotational motion of the elongated flexible object 204 while providing minimal translational friction. As the disk 228 rotates in response to the rotational motion of the elongated flexible object 204, the rotation of the disk 228 is detected by rotation sensor 224. Hollow shaft 232 can be made from stainless steel. The hollow shaft 232 is dimensioned so as to engagably receive the elongated flexible object 204 with a gap between the hollow, shaft 232 and elongated flexible object 204 sufficient to allow translation of the elongated flexible object without substantial interference from the interior surface of the hollow shaft 232; yet small enough that the hollow shaft rotates substantially continuously with the elongated flexible object. In one embodiment, the hollow shaft 232 includes at least one bend. In another embodiment, and as shown in the figure, the hollow shaft 232 includes two bends substantially oppositely oriented. In another embodiment, sections of the hollow shaft 232 on opposite sides of the bend(s) are substantially parallel. The bend(s) function to allow the hollow shaft and disk 228 to track the rotational motion of the elongated flexible object while offering little impedance to the translational movement of the elongated flexible object. In this way the rotation of the flexible elongated medical instrument is detected, creating an electrical signal from rotation sensor 224 which is recorded by interface 104 (also not shown).

Having described an exemplary configuration of the sensing and feedback transducer mechanism 120 above with respect to FIGS. 3, 4A, and 4B, an exemplary process in which the sensing and feedback transducer mechanism 120 operates to generate spatially-metered haptic sensations will now be provided.

Generally, the sensing and feedback transducer mechanism 120 senses the linear and rotational motion of the elongated flexible object 204 passing therethrough before it is fed, by an operator, into the body of the patient (e.g., via a tubular body organ). Accordingly, the sensing and feedback transducer mechanism 120 can sense the insertion, retraction, and/or rotation of the flexible elongated object 204 as it is manipulated within the body of the patient by the operator. The sensing and feedback transducer mechanism 120 further imparts haptic sensations to the flexible elongated object 204 at a location that is near to where the operator will manually engaged the instrument, the haptic sensations including haptic metering sensations as described throughout this document.

The electronic interface 104, alone or in combination with computer 106, serves as control electronics that uses the signals from the linear transducer 224 to determine if and when the object 204 has moved forward or backward by a particular incremental distance, wherein the particular incremental distance is defined by one or more spacing values stored in memory within the electronic interface 104 and/or the computer 106. When the control electronics determines that the object 204 has translated forward or backward by a particular incremental distance as defined by the one or more spacing values stored in memory, the control electronics control the actuator 206 to impart a tick mark sensation by energizing the actuator with an appropriate profile of energizing electricity. In a basic embodiment, a quick profile of current is sent to the actuator whenever it is determined that the incremental distance has been traversed, driving the voice coil quick up and back, impacting the object and sending an impulse sensation to the user through the flexible wire. As the user manipulates the flexible elongated medical instrument object forward and/or backward, moving by the incremental distance forward and/or backward, the quick profiles of current are repeatedly sent to the actuator giving the user tick mark sensations as the object repeatedly moves by the incremental distance. If, for example the spacing value was set to 1 millimeter, when the user moved the flexible elongated medical instrument object forward by 1 millimeter, the impulse sensation would be imparted. If the user continued to move the flexible elongated medical instrument object forward, another impulse sensation would be imparted when sensor readings determined that the object moved forward by another 1 millimeter increment. If the user continued to move the flexible elongated medical instrument object forward, another impulse sensation would be imparted when sensor readings determined that the object moved forward by another 1 millimeter increment. In this way, if the user inserted the flexible elongated medical instrument forward into the patient by 12 millimeters, the user would feel 12 tick mark sensations, each of the 12 tick mark sensations being spatially coordinated with the crossing of a subsequent 1 millimeter spatial increment during the insertion. If the user then retracted the flexible elongated medical instrument, pulling the instrument out of the patient by 5 millimeters, the user would feel 5 tick mark sensations, each of the 5 impulse tick mark sensations being spatially coordinated with the crossing of a subsequent 1 millimeter spatial increment during the retraction. In this way the user is provided with spatial situational awareness in the form of artificially produced tick mark sensations that correspond to incremental spatial translations of the elongated flexible surgical instrument.

The electronic interface 104, alone or in combination with computer 106, serves as control electronics that uses the signals from the rotation sensor 224 to determine if and when the object 204 has rotated clockwise or counterclockwise by a particular incremental angle, wherein the particular incremental angle is defined by one or more spacing values stored in memory within the electronic interface 104 and/or the computer 106. When the control electronics determines that the object 204 has rotated clockwise or counterclockwise by a particular incremental angle as defined by the one or more spacing values stored in memory, the control electronics control the actuator 206 to impart a tick mark sensation by energizing the actuator with an appropriate profile of energizing electricity. In a basic embodiment, a quick profile of current is sent to the actuator whenever it is determined that the incremental angle has been rotationally traversed, driving the voice coil quick up and back, impacting the object and sending an impulse sensation to the user through the flexible wire. As the user manipulates the flexible elongated medical instrument object clockwise and/or counterclockwise by the incremental angle, the quick profiles of current are repeatedly sent to the actuator giving the user tick mark sensations as the object repeatedly moves by the incremental angle amount. If for example the spacing value was set to 30 degrees, when the user rotates the flexible elongated medical instrument clockwise by 30 degrees, the impulse sensation is imparted. If the user continues to rotate the flexible elongated medical instrument object clockwise, another impulse sensation is imparted when sensor readings determined that the object rotated clockwise by another 30 degree increment. If the user continued to rotate the flexible elongated medical instrument object clockwise, another impulse sensation would be imparted when sensor readings determined that the object rotated clockwise by another 30 degree increment. In this way if the user rotated the flexible elongated medical instrument clockwise within the patient by 300 degrees, the user would feel 10 tick mark sensations, each of the 10 tick mark sensations being spatially coordinated with the crossing of a subsequent 30 degree angular increment during the rotation. If the user then rotated the flexible elongated medical instrument counterclockwise by 180 degrees, the user would feel 6 tick mark sensations, each of the 6 impulse tick mark sensations being spatially coordinated with the crossing of subsequent 30 degree angular increments during the counterclockwise rotation. In this way the user is provided with spatial situational awareness in the form of artificially produced tick mark sensations that correspond to incremental angular rotations of the elongated flexible surgical instrument.

Accordingly, and as described above, the striking portion 214 of the actuator 206 is controlled under electronic and/or software control to impart tick mark haptic sensations upon the user through the object 204, the electronic control involving the generation of tick mark haptic sensations based upon the detected translation and/or rotation of the object 204 by sensors, the tick mark haptic sensations being generated based upon incremental translations and/or incremental rotations of the object 204.

As described above, tick mark sensations can be provided for insertion, retraction, clockwise rotation, and clockwise rotation of the flexible elongated object 204. In some embodiments of the present invention, tick mark sensations with tactilely distinct profiles are used for linear motions as compared to those used for rotary motions of the flexible elongated medical instrument. In some embodiments of the present invention tick mark sensations with tactilely distinct profiles are used for insertion motions (e.g., motion in a first direction) as compared to those used for retraction motions (e.g., motion in a second direction) of the flexible elongated object 204. In some embodiments of the present invention tick mark sensations with tactilely distinct profiles are used for clockwise rotations as compared to those used for counterclockwise rotations of the flexible elongated medical instrument. Finally, in some embodiments of the present invention a variety of tactilely distinct tick mark sensations are used as defined by the user through the user interface of computer 206.

As mentioned previously, embodiments of the present invention are applicable to augmented surgical procedures that allow the user to directly manipulate the flexible elongated object 204 (e.g., a medical instrument that enters the patient's body) and receive haptic metering sensations imparted by one or more actuators. In such augmented medical procedure applications, the haptic sensations may be imparted upon the user through a portion of the flexible elongated object 204 that the user contacts. In this way a portion of the flexible elongated object 204 resides within the body of the patient, inserted within a tubular body organ, and a portion of the flexible elongated object 204 is held by the user and manually manipulated. In such embodiments the user receives direct physical feedback as he or she manipulates the flexible elongated object 204 as well as supplemental feedback from the haptic actuator producing the haptic metering sensations.

As mentioned previously, embodiments of the present invention are applicable to master/slave medical procedures wherein the user does not directly manipulate the flexible elongated medical instrument that enters the patient's body, but rather manipulates a master controller and thereby controls the flexible elongated medical instrument through an intervening robotic mechanism.

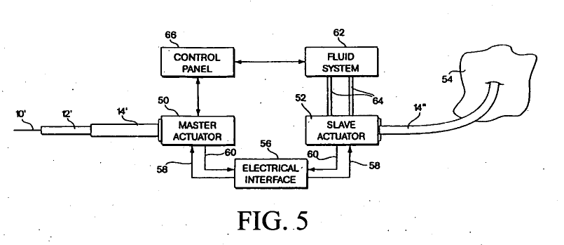

FIG. 5 schematically illustrates a master/slave catheterization system capable of tracking the motion of a master as imparted by a user and capable of providing haptic feedback to the user through the master.

Referring to FIG. 5, an exemplary master/slave catheterization system employs catheter-like cylindrical controls 10′, 12′ and 14′ that are part of a master actuator 50. A slave actuator 52 senses and controls the movement of a catheter 14″, as well as a catheter 12″ and a wire 10″ not shown in FIG. 2, within a patient 54. The master actuator 50 and slave actuator 52 are electrically coupled to electrical interface circuitry 56 by respective drive signals 58 and sense signals 60. A fluid system 62 is coupled to the slave actuator 52 by fluid-carrying tubes 64. Various system operations are controlled by a control panel 66. These operations include the injection of contrast and other fluids into the vasculature through the catheter 14, and into the balloon 16 in order to inflate it. The fluid system 62 includes electrically-operated valves responsive to control signals from the control panel 66. The system optionally performs a sequence of timed inflations of the balloon 16 in response to input at the control panel 66. This feature improves upon prior methods of inflating the balloon 16 to enlarge the restricted opening.

The actuators 50 and 52 contain sensors that sense translation and rotation of the controls 10′, 12′ and 14′ and the tools 10″, 12″ and 14″ with respect to their respective longitudinal axes. Pulse signals 60 indicative of these motions are provided to the interface circuitry 56. The actuators 50 and 52 also contain motors respectively engaging the controls 10′, 12′ and 14′ and the tools 10″, 12″ and 14″. The motors cause translational and rotational movement of these components about their respective axes in response to the drive signals 58 generated by the interface circuitry 56.

In one embodiment, the electrical interface circuitry 56 includes electrical driver and amplifier circuits for the signals 58 and 60, and a processor coupled to these circuits. A detailed disclosure of a processor based controller that is well adapted for generating a variety of haptic sensations is disclosed in U.S. Pat. No. 5,734,373 by the present inventor and is hereby incorporated by reference. In the present embodiment the processor also executes a master-slave control program that uses information from the sense signals 60 to generate the drive signals 58 such that the catheters 12″ and 14″ and the wire 10″ move within the patient 54 in a manner dictated by the controls 10′, 12′ and 14′. These movements include both translation and rotation with respect to the longitudinal axis of the corresponding catheter or wire. The master-slave control program can be of the type known as “position matching”. In this type of control program, the signals 58 and 60 are used to ensure, if possible, that the relative positions of each control 10′, 12′ and 14′ and the corresponding wire 10″ or catheter 12″ or 14″ do not change. For example, assuming an initial position of control 14′ and catheter 14″, if a user pushes control 14′ inwardly by one inch, the control program responds by pushing catheter 14″ in by one inch. If the catheter 14″ encounters an obstacle during this movement, a feedback force is generated on the control 14′ that opposes the user's movement in an attempt to bring the position of the control 14′ to the (blocked) position of the catheter 14″.

One of the benefits of a master/slave control system is the ability to choose how the slave device responds to any particular input from the master device. For example, it is known to provide functions such as force or position scaling and tremor reduction. When force or position scaling are used, the slave responds to the master by applying a similar force or moving to a similar position, but scaled by some constant value. For example, in a system implementing 5:1 position scaling the slave would move one inch for every five inches of movement of the master. Scaling can also be applied in the other direction, from the slave to the master, and in fact the two are usually used together to achieve the full desired effect. Scaling enables a user to manipulate small tools while interacting with a much larger control on the master. Tremor reduction involves filtering the master input such that a pattern found to be periodic within a particular frequency band has a more attenuated affect on movement of the slave than do other types of movement. The electrical interface 56 optionally employs force or position scaling, tremor reduction, and other similar techniques that enhance the effectiveness of the master/slave system.

In addition to such control paradigms, the master/slave system of the present invention is configured to provide artificially generated and imparted haptic tick mark sensations as described previously and correlated to incremental motion of the master controller. For embodiments that include a plurality of independently controllable master controls, haptic tick mark sensations may be independently generated and imparted for each of the independently controllable master controls. With respect to the generation of haptic tick mark sensations, electrical interface circuitry 56 uses sense signals 60 to determine if and when a control (either 10′, 12′ or 14′) has moved forward or backward by a particular incremental distance, the incremental distance being defined by one or more spacing values stored in memory. When the electronics determines that a control, for example 10′, has translated forward or backward by a particular incremental distance as defined by the one or more spacing values stored in memory, the electronics energize an appropriate motor (or other similar transducer) by generating a particular profile of drive signals 58 to impart a tick mark sensation by energizing the motor with an appropriate profile of energizing electricity. In a basic embodiment, a quick profile of current is sent to the motor associated with a particular master control whenever it is determined that the incremental distance has been traversed by the control, driving the motor to impart a quick impulse of force upon the control and sending an impulse sensation to the user as he or she manually contacts the control. As the user manipulates the control object forward and/or backward, moving by the incremental distance forward and/or backward, the quick profiles of current are repeatedly sent to the actuator giving the user tick mark sensations as the master control object repeatedly moves by the incremental distance. If for example the spacing value was set to 1 millimeter, when the user moved the master control object forward by 1 millimeter, the impulse sensation would be imparted. If the user continued to move the master control object forward, another impulse sensation would be imparted when sensor readings determined that the master control object moved forward by another 1 millimeter increment. If the user continued to move the master control object forward, another impulse sensation would be imparted when sensor readings determined that the control object moved forward by another 1 millimeter increment. In this way if the user moved the master control forward by 12 millimeters, the user would feel 12 tick mark sensations, each of the 12 tick mark sensations being spatially coordinated with the crossing of a subsequent 1 millimeter spatial increment during the insertion. If the user then retracted the master control, pulling the master back by 5 millimeters, the user would feel 5 tick mark sensations, each of the 5 impulse tick mark sensations being spatially coordinated with the crossing of a subsequent 1 millimeter spatial increment during the retraction. In this way the user is provided with spatial situational awareness in the form of artificially produced tick mark sensations that correspond to incremental spatial translations of the master control as the master/slave system guides the catheter into and out of the patient through the previously described master-slave control scheme. In another embodiment, a similar tick mark sensation generation paradigm as described above for translation motion of a master control can be implemented for the rotation motion of a master control. Also, as described previously, the form and spacing of the tick mark sensations are highly customizable by the user through a user interface provided by the system. Furthermore, the electronics may generate a plurality of different tick mark sensations, each of the plurality being distinct and user differentiable by feel. A control paradigm may be implemented such that each of the distinct and user-differentiable haptic tick mark sensations are associated with and imparted in response to motion of a different one of a plurality of master controls, a different one of a plurality of directions of motion of the master controls, and/or a different one of a plurality of degrees of freedom of motion of the master controls.

With respect to rotation of a master control, here is additional description of how haptic tick market sensations are imparted in some embodiments: electrical interface circuitry 56 uses sense signals 60 to determine if and when a control (either 10′, 12′ or 14′) has rotated clockwise or counterclockwise by a particular incremental angle, the incremental angle being defined by one or more spacing values stored in memory. When the electronics determines that a master control, for example master control 10′, has rotated clockwise or counterclockwise by a particular incremental angle as defined by the one or more spacing values stored in memory, the electronics energize an appropriate motor (or other similar transducer) by generating a particular profile of drive signals 58 to impart a tick mark sensation by energizing the motor with an appropriate profile of energizing electricity. In a basic embodiment, a quick profile of current is sent to the motor whenever it is determined that the incremental angle has been rotationally traversed by the master control, driving the motor to impart a quick impulse of force upon the control and sending an impulse sensation to the user as he or she manually contacts the control. As the user manipulates the master control clockwise and/or counterclockwise by the incremental angle, the quick profiles of current are repeatedly sent to the motor giving the user tick mark sensations as the master control object repeatedly moves by the incremental angle amount. If for example the spacing value was set to 30 degrees, when the user rotates the master control object by 30 degrees, the impulse sensation is imparted. If the user continues to rotate the master control object, another impulse sensation is imparted when sensor readings determined that the object rotated clockwise by another 30 degree increment. If the user continued to rotate the object clockwise, another impulse sensation would be imparted when sensor readings determined that the object rotated clockwise by another 30 degree increment. In this way if the user rotated the master control object clockwise by 300 degrees, the user would feel 10 tick mark sensations, each of the 10 tick mark sensations being spatially coordinated with the crossing of a subsequent 30 degree angular increment during the rotation. If the user then rotated the master control object counterclockwise by 180 degrees, the user would feel 6 tick mark sensations, each of the 6 impulse tick mark sensations being spatially coordinated with the crossing of subsequent 30 degree angular increments during the counterclockwise rotation. In this way the user is provided with spatial situational awareness in the form of artificially produced tick mark sensations that correspond to incremental angular rotations of the master control as the master/slave system rotates the catheter clockwise and counterclockwise within the tubular organ of the patient by implementing the previously described master-slave control scheme

In the examples above tick mark sensations are provided for insertion, retraction, clockwise rotation, and clockwise rotation of the master control as it is used to command the slave medical instrument. In some embodiments of the present invention, tick mark sensations with tactilely distinct profiles are used for linear motions as compared to those used for rotary motions of the master control. In some embodiments of the present invention tick mark sensations with tactilely distinct profiles are used for insertion motions as compared to those used for retraction motions of the master control. In some embodiments of the present invention tick mark sensations with tactilely distinct profiles are used for clockwise rotations as compared to those used for counterclockwise rotations of the master control. Finally, in some embodiments of the present invention a variety of tactilely distinct tick mark sensations are used as defined by the user through a user interface of the master/slave system.

Finally, the master/slave system may also provide traditional haptic feedback sensations that realistically represent the physical interaction between the elongated flexible medical instrument and the body tissue of the patient. In such cases, one embodiments of the present invention may be configured to present the user with combined haptic sensations that merge the realistic feedback sensations with the artificially generated tick mark sensations such that they are simultaneously imparted upon the user if and when they occur simultaneously in time. Such merging is enacted in some embodiments by summing the activation profiles representing the realistic sensations with the activation profiles representing the tick mark sensations and then energizing the motor (or other similar actuating traducer) with the summation activation profile. In such embodiments the user can selectively adjust the relative strength of the realistic feedback sensation and the artificial tick mark sensation in the summing algorithm thereby allowing the user to selectively accentuate one or the other. For example, one user may desire a very mild tick mark sensation such that it feels to be a subtle background cue as compared to the realistic feedback sensations that represent the real physical interactions between the elongated flexible medical instrument and the body tissue of the patient. Another user may desire stronger tick mark sensations that feel more pronounced in relation to the realistic feedback sensations that represent the real physical interactions between the elongated flexible medical instrument and the body tissue of the patient.

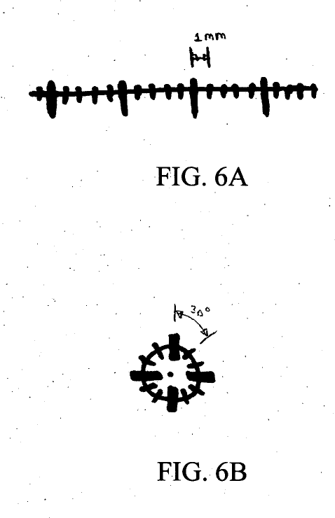

FIG. 6A schematically illustrates a set of translational haptic tick mark sensations in accordance with one exemplary embodiment of the present invention. FIG. 6B schematically illustrates a set of rotational haptic tick mark sensations in accordance with one exemplary embodiment of the present invention.

Referring to FIGS. 6A and 6B, the graphical tick marks represent the relative spatial location of haptic sensations described throughout this document as tick mark sensations. Conceptually, the graphical tick marks can be thought of as boundaries between successive spatial increments. When the increment boundaries are crossed, associated haptic tick mark sensations are generated. Both FIGS. 6A and 6B show two types of graphical tick marks: small tick marks and large tick marks. The two types of graphical tick marks schematically represent two types of haptic tick mark sensations, each of which is tactually distinct from the other. In one embodiment the small graphical tick marks represent haptic tick mark sensations of lesser intensity and the large graphical tick marks represent haptic tick mark sensations of greater intensity. In this way, the user feels the tick marks that are drawn schematically as small tick marks as lesser intensity haptic sensations and the user feels tick marks that are drawn schematically as large tick marks as greater intensity haptic sensations. In this context the lesser intensity haptic sensations impart a force profile upon the user that is of lower magnitude and/or shorter duration than the greater intensity haptic sensations.

Referring specifically to FIG. 6A, the schematic representation shown depicts a haptic metering implementation wherein haptic tick mark sensations correspond to 1.0 mm translational increments along the insertion-retraction degree of freedom of the flexible elongated object 204 (e.g., a medical instrument). As the user inserts or retracts the flexible elongated medical instrument (or master controller thereof), the user feels sensations as the instrument (or master controller thereof) translates forward or backward across the 1.0 mm increment demarcations. With respect to the schematic drawing shown in FIG. 6A, the haptic metering sensation can be thought of as follows: as the flexible elongated medical instrument is moved in translation, a fixed point upon the instrument will translate forward or backwards (depending upon the direction of motion imparted by the user) with respect to the patient and cross the schematic tick marks drawn in the figure. As each graphical tick mark is crossed, a haptic tick mark sensation is generated and imparted upon the user. In this way a spatial layout of haptic tick marks is established, each of the marks spatially correlated with an incremental distance within the translational motion space of the flexible elongated medical instrument (or master controller thereof), the translational motion space being the linear insertion and/or retraction of the instrument into or out of the patient. As shown in FIG. 6A, every fifth tick mark is a larger tick mark with the four intervening tick marks being a smaller tick mark. This spatial pattern is drawn to represent a similar spatial pattern of haptic tick marks implemented by the control electronics such that every fifth tick mark sensation is a greater intensity haptic tick mark sensation and the four intervening tick mark sensations are lesser intensity haptic tick mark sensations. In this way, as the user moves the flexible elongated medical instrument (or master controller thereof) forward or backward, he or she will get increased situational awareness, for he or she will feel two different and distinct haptic tick mark sensations, the less intense sensation being felt as the user translates forward or backward across the majority of 1 mm increments and the more intense sensation being felt as the user translates forwards or backwards across every fifth increment. In one embodiment, the increments are spatially arranged with respect to a fixed reference frame such that the haptic tick mark cues give the user reference information with respect to that fixed reference frame. For example, if a user inserted a flexible catheter into a patient by a distance of 12.2 mm using a system enabled with the haptic metering hardware, software, and electronics, disclosed herein, the hardware software and electronics configured to impart a haptic metering spatial arrangement of tick marks as discussed with respect to FIG. 6A, that user would feel a sequence of 12 tick mark sensations, the sequence including lesser intensity haptic tick mark sensations every 1 mm increment and greater intensity haptic tick mark sensations every 5 mm increment such that the user might feel the sequence [lesser, lesser, lesser, lesser, greater, lesser, lesser, lesser, lesser, greater, lesser, lesser] as the user translated the medical instrument forward by the 12.2 mm. Note, in the sequence the word lesser means “lesser intensity haptic tick mark sensation” and the world greater means “greater intensity haptic tick mark sensation”. In one embodiment, the specific sequence felt by the user depends upon the location of the flexible elongated medical instrument with respect to the fixed reference frame when the motion was begun. For example, if the 12.2 mm insertion translation imparted by the user had occurred when the elongated medical instrument was at a different starting location, the sequence might have been: [lesser, lesser, greater, lesser, lesser, lesser, lesser, greater, lesser, lesser, lesser, lesser]. Furthermore, if the medical instrument had started at the same location as the previous example and was inserted 4.1 mm and then retracted by 4.2 mm, the sequence felt would be: [lesser, lesser, greater, lesser, lesser, greater, lesser, lesser]. These three sequences are given to illustrate what is meant by the fixed reference frame and to further detail how a spatial pattern of haptic metering tick mark sensations, such as the one shown in FIG. 6A, is imparted upon the user by the control electronics and software based upon incremental translation of the surgical instrument (or master controller thereof) with respect to the fixed reference frame.

Referring specifically to FIG. 6B, the schematic representation shown depicts a haptic metering implementation wherein haptic tick mark sensations correspond to 30 degree angular increments along the rotary degree of freedom of the flexible elongated object 204 (e.g., a medical instrument). As the user rotates the flexible elongated medical instrument (or master controller thereof) clockwise or counter-clockwise, the user feels sensations as the instrument (or master controller thereof) rotates past the 30 degree angular increment demarcations. With respect to the schematic drawing shown in FIG. 6B, the haptic metering sensation can be thought of as follows: as the flexible elongated medical instrument is rotated, a fixed point upon the instrument will rotate clockwise or counter-clockwise with respect to the patient (depending upon the direction of rotation imparted by the user) and thereby cross the angular schematic tick marks drawn in the figure. As each graphical tick mark is crossed, a haptic tick mark sensation is generated and imparted upon the user. In this way an angular spatial layout of haptic tick marks is established, each of the marks spatially correlated with angular increments within the rotational motion space of the flexible elongated medical instrument (or master controller thereof), the rotational motion space being the clockwise and/or counter clockwise rotational degree of freedom of the instrument. As shown in FIG. 6, every third tick mark is a larger tick mark with the two intervening tick marks being a smaller tick mark. This spatial pattern is drawn to represent a similar spatial pattern of haptic tick marks implemented by the control electronics such that every third tick mark sensation is a greater intensity haptic tick mark sensation and the two intervening tick mark sensations are lesser intensity haptic tick mark sensations. In this way, as the user moves the flexible elongated medical instrument (or master controller thereof) clockwise or counterclockwise, he or she will get increased situational awareness, for he or she will feel two different and distinct haptic tick mark sensations, the less intense sensation being felt as the user rotates across the majority of 30 degree increments and the more intense sensation being felt as the user rotates across every third 30 degree increment. In one embodiment, the increments are spatially arranged with respect to a fixed reference frame such that the haptic tick mark cues give the user reference information with respect to that fixed reference frame. For example, if a user rotated a flexible catheter within a patient by an clockwise angle of 190 degrees using a system enabled with the haptic metering hardware, software, and electronics, disclosed herein, the hardware software and electronics configured to impart a haptic metering spatial arrangement of tick marks as discussed with respect to FIG. 6B, that user would feel a sequence of 7 tick mark sensations, the sequence including lesser intensity haptic tick mark sensations every 30 degree increment and greater intensity haptic tick mark sensations every 90 degree increment. Depending upon where the catheter was located at the start of the 190 degree clockwise rotation, the user might feel the sequence [greater, lesser, lesser, greater, lesser, lesser, greater] as the user rotated the medical instrument clockwise by the 190 degrees. Note, in the sequence the word lesser means “lesser intensity haptic tick mark sensation” and the world greater means “greater intensity haptic tick mark sensation”. In one embodiment, the specific sequence felt by the user depends upon the location of the flexible elongated medical instrument with respect to the fixed reference frame when the motion was begun. For example, if the 190 degree clockwise rotation imparted by the user had occurred when the elongated medical instrument was at a different starting angle with respect to the fixed reference, the sequence might have been: [lesser, lesser, greater, lesser, lesser, greater, lesser]. Furthermore, if the medical instrument had started at the same angular location as the previous example and was rotated 92 degrees clockwise and then rotated 65 degrees counterclockwise, the sequence felt would be: [lesser, lesser, greater, greater, lesser]. These three sequences are given to illustrate what is meant by the fixed reference frame and to further detail how a spatial pattern of haptic metering tick mark sensations, such as the one shown in FIG. 6B, is imparted upon the user by the control electronics and software based upon incremental angular rotation of the surgical instrument (or master controller thereof) with respect to the fixed reference frame.

In some embodiments of the present invention tick mark sensations can be implemented in electronics and/or software with a tactile form that is dependent upon the direction in which the elongated flexible object 204 (e.g., a medical instrument or master controller thereof) is moving when it crosses the increment boundary. For example, the control electronics and/or software running within the control electronics is configured in some embodiments of the present invention to impart a different haptic tick mark sensation when the increment boundary is crossed through an insertion motion as compared to when the same increment boundary is crossed through a retraction motion. In this way the user can feel the difference between insertion and retraction. And in some embodiments one of the insertion or retraction direction can be associated with no sensation at all. For example, the system can be configured such that certain haptic tick mark sensations are associated with the crossing of certain increment boundaries when the elongated flexible medical instrument (or master controller thereof) is moving in an insertion direction, but that no haptic tick mark sensations are associated with the crossing of the certain increment boundaries when the elongated flexible medical instrument (or master controller thereof) is moving in a retraction direction. In this way the system can be configured such that the user only feels those particular haptic tick mark sensations when he or she inserts the flexible elongated medical instrument, but feels no haptic tick mark sensations when he or she retracts the flexible elongated medical instrument across the same increment boundaries.

In some embodiments of the present invention the haptic tick mark sensations may be selectively applied by the operator depending upon the action he or she is performing. At times he or she may want to feel the incremental tick mark sensations, at other times he or she may not. To facilitate the application and removal of the haptic tick mark sensations without requiring the user to take his or her hands and/or his or her attention away from the medical procedure, a foot pedal is included in some embodiments of the present invention, the foot pedal interfaced with the control electronics and/or control computer such that the control electronics and/or control computer can detect the state of the foot pedal and respond accordingly. In some embodiments of the present invention, the foot pedal is a foot activated digital switch with an on-state and an off-state that may be toggled between by foot action. When the switch is in one state, for example the on-state, the control electronics and/or control computer applies the haptic tick mark sensations through the one or more actuators employed within the system such that the user feels the haptic tick mark sensations as he or she moves the elongated flexible medical instrument as described previously. When the switch is in another state, for example the off-state, the control electronics and/or control computer does not energize the one or more actuators employed within the system such no haptic tick mark sensations are produced as the user moves the elongated flexible medical instrument. In this way, by toggling the state of the foot pedal, the user can selectively engage and disengage the haptic tick mark sensations. In the one embodiment the control electronics and/or control computer still keeps track of the motion of the elongated flexible medical instrument with respect to the reference frame of the haptic tick mark sensations when the sensations are disengaged, but does not energize the actuators to actually produce them when the foot pedal is in the off-state. In this way, when the foot pedal is toggled and the haptic tick mark sensations are engaged by the control electronics and/or control computer, there is no shift in location of the haptic tick mark sensations with respect to the reference frame. In some embodiments, the foot pedal is a replaced by a button, toggle switch, lever, or other manually controllable element that is affixed to or configured upon a portion of the medical instrument such that it can be engaged by the user conveniently while performing the procedure. In some embodiments the foot pedal or the manually controllable element has more than two states, the more than two states being used to individually engage or disengage haptic tick mark sensations associated with each of a plurality of degrees of freedom of the flexible elongated medical instrument (such as translation and rotation). In this way a user can individually engage or disengage translation related haptic tick mark sensations and rotation related haptic tick mark sensations. Similarly in some embodiments the foot pedal or the manually controllable element has more than two states, the more than two states being used to individually engage or disengage haptic tick mark sensations associated with each of a plurality of individually controllable portions of a flexible elongated medical instrument (such as an inner portion and an outer portion). In this way a user can individually engage or disengage inner portion related haptic tick mark sensations and outer portion related haptic tick mark sensations. Also, in some embodiments of the present invention the user modified state of the foot pedal and/or the manually controllable element, as detected by the control electronics and/or control computer, is used to selectively modify the haptic tick mark sensations and/or select among a plurality of different haptic tick mark sensations, for example altering the magnitude of the tick mark sensations, altering the incremental spacing between tick mark sensations, and/or altering the pattern of distinct haptic tick marks within a set of haptic tick mark sensations. In this way an operator can, for example, toggle a foot pedal or adjust a manual control to quickly switch between finely spaced haptic tick mark sensations and coarsely spaced haptic tick mark sensations.

As mentioned previously, minimally invasive surgical procedures involving flexible elongated surgical instruments are often “image guided,” meaning they employ a display technology used to show the operator the location of the flexible surgical instrument within the tubular body organ. A common imaging method is fluoroscopy. Other imaging technologies include, for example, computed tomography (CT), magnetic resonance imaging (MRI), and ultrasound. Regardless of the type of imaging technology employed, a further enhancement to the current invention involves the presentation of a visual representation of spatial intervals employed by a given set of haptic tick mark sensations upon or within a medical image used for image guiding a minimally invasive procedure. For example, the visual display of medical imagery presented to the user, whether it be by fluoroscopic image, CT image, MRI image, ultrasound image, or other type of medical image, is enhanced with visually drawn demarcations that correspond with the spacing and layout of the then currently engaged haptic tick mark sensations. For example a visual grid and or a visual display of lines or dots representing the spacing and location of the then current haptic tick mark sensations is presented upon the fluoroscopic image display (either as an opaque image or a semi-transparent image), the visual grid or lines or dots or other displayed graphical marks corresponding with the haptic tick marks felt by the user. In this way the user has further enhanced situational awareness as he or she manipulates the surgical instrument, feeling tick marks manually and relating them to the visual marks displayed upon the fluoroscopic image (or image from whatever other medical imaging technology employed for image guiding purposes). This visual display is particularly useful for image guided procedures in which the visual image is not continuously updated in real-time throughout the procedure for it gives the operator a visual reference to correlate to the haptic tick marks between updates of the medical imagery.

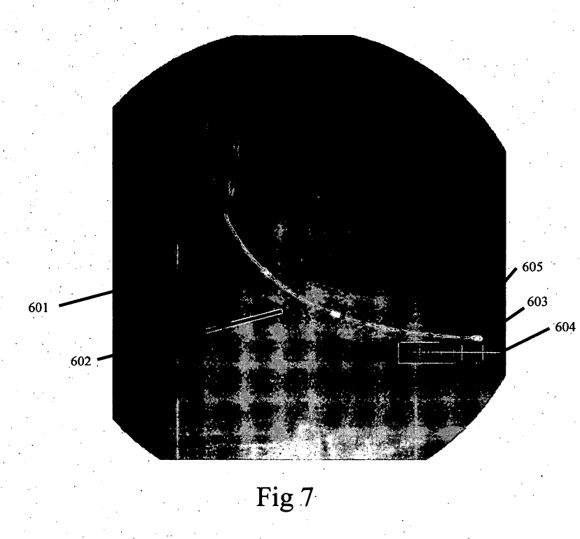

FIG. 7 shows an example fluoroscopic image as might be captured and displayed to an operator during a catheter based procedure. As shown in the image a catheter (601) has been inserted into a bronchial tube of a patient and a stent (602) has been inserted. The image as currently displayed is captured using X-ray radiation and so it is sparingly updated during the procedure. At the moment in time shown, the image is frozen, depicting the state of the patient and medical instruments as of the last X-ray update requested of the operator. The catheter has not yet been moved, so the image although frozen accurately represents the relative location of the elongated flexible medical instrument with respect to the body of the patient, but as soon as the operator starts moving the catheter, the image will no longer be up-to-date and the user will need to estimate the position the current position of the catheter tip (603) with respect to the frozen image by estimating how far he or she manipulates the catheter. However the haptic metering methods and apparatus of the present invention provide a substantial advantage, for the user is presented with haptic tick mark sensations as he or she manipulates the catheter and can thereby feel the incremental motion of the catheter as it moves and thereby better estimate the position of the catheter between image updates. Furthermore, as shown in FIG. 7 a visual image (604) of the spatial layout of haptic tick marks can optionally be presented upon the medical image, the visual image (604) of the spatial layout of haptic tick marks showing the pattern and spacing of haptic tick mark sensations that are generated, the image correlated to the reference frame of the haptic tick mark sensations. In this way the user can visually see general location of the tick mark sensations that he or she is feeling. This may be useful in situations such that the current example in which the user manipulates the catheter between updates if the medical image used for image guided operation. This is because the user can feel the haptic tick marks as the catheter is moved and by counting tick marks can have a much better sense of where the tip of the catheter prior to the image being updated. For example, if the user retracted the catheter in the current example and felt four lesser magnitude tick sensations and one greater magnitude tick mark sensations, the user would know by counting tick marks and/or by looking that the visual display of tick marks, the general location of the tip of the catheter (which would be near the location marked 605 in the figure). Clearly the method of haptic metering may be useful for image guided procedures in which the imagery are sparingly updated. Furthermore, in many image guided medical procedures, the imagery may be updated frequently but it may not be clear, may be at a difficult to comprehend at the current imaging angle, may have portions that are obscured or blurred, and/or may not provide sufficient depth perception to the user. In all such cases the addition of haptic tick mark sensations provide enhanced situational awareness to the operator and the further optional addition of a visual representation of the spatial layout of haptic tick marks provided further enhanced situational awareness to the operator.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of providing spatially metered haptic sensations to a user, comprising:
detecting motion of a surgical instrument within two degrees of freedom;
repeatedly determining whether the surgical instrument has moved by an incremental distance in a particular direction with respect to some portion of a patient's body; and
imparting a discrete haptic sensation upon a user each time it is determined that the surgical instrument has moved by the incremental distance in a particular direction.

2. The method of claim 1, wherein a first of the two degrees of freedom is a translational degree of freedom and a second of the two degrees of freedom is a rotational degree of freedom.

3. The method of claim 2, further comprising:
determining the degree of freedom within which the surgical instrument has moved; and
imparting a discrete haptic sensation corresponding to the determined degree of freedom.

4. The method of claim 1, further comprising:
imparting a first discrete haptic sensation upon determining that the surgical instrument has moved a single incremental distance; and
imparting a second discrete haptic sensation upon determining that the surgical instrument has moved a predetermined number of incremental distances.

5. The method of claim 4, further repeatedly imparting the first and second discrete haptic sensations to produce a repeating pattern of haptic sensations each time the surgical instrument is moved by a multiple of incremental distances in a particular direction.

6. The method of claim 1, further comprising:
determining the particular direction that the surgical instrument has moved; and
imparting a discrete haptic sensation corresponding to the determined direction.

7. The method of claim 1, wherein the surgical instrument is adapted to be contacted by the user, the method further comprising imparting the discrete haptic sensation to the user via the surgical instrument.

8. The method of claim 7, wherein imparting the discrete haptic sensation includes imparting an active force to the surgical instrument.

9. The method of claim 7, wherein imparting the discrete haptic sensation includes imparting a resistive force to the surgical instrument.

10. The method of claim 1, wherein the surgical instrument comprises at least one of a catheter or a scope adapted to be inserted into a patient.

11. The method of claim 1, wherein the surgical instrument comprises a master controller in a master-slave surgical system.

12. The method of claim 1, further comprising enabling adjustment of at least one of a quality and quantity of imparted discrete haptic sensations during the detecting.

13. The method of claim 1, further comprising enabling adjustment of the incremental distance during a surgical procedure.

14. The method of claim 1, further comprising enabling selective imparting of the discrete haptic sensation during a surgical procedure.

15. The method of claim 1, further comprising displaying a graphical representation of the imparted discrete haptic sensations to the user.

16. The method of claim 2, wherein
the surgical instrument includes catheter; and
the translational degree of freedom is an insertion of the catheter into a vascular organ of the patient's body.

17. The method of claim 16, wherein the discrete haptic sensations provide the user with discrete haptic indications of the amount of incremental insertion of the catheter into the length of the vascular organ.

18. A method of providing spatially metered haptic sensations to a user, comprising:
defining a plurality of simulated spacing markers with an incremental distance between them;
detecting motion of an elongated flexible object;
repeatedly determining whether the elongated flexible object has moved past a simulated spacing marker; and
imparting a discrete haptic sensation upon a user each time it is determined that the elongated flexible object has moved past a simulated spacing marker in a particular direction.

19. The method of claim 18, further comprising detecting motion of the elongated flexible object within at least one of two degrees of freedom.

20. The method of claim 19, wherein a first of the two degrees of freedom is a translational degree of freedom and a second of the two degrees of freedom is a rotational degree of freedom.

21. The method of claim 20, further comprising:
determining the degree of freedom within which the elongated flexible object has moved; and
imparting a discrete haptic sensation corresponding to the determined degree of freedom.

22. The method of claim 18, further comprising:
determining whether the elongated flexible object has moved past a first type or a second type of the plurality of simulated spacing markers; and
imparting a discrete haptic sensation corresponding to the determined type of simulated spacing markers.

23. The method of claim 22, further comprising:
imparting a first discrete haptic sensation upon determining that the elongated flexible object has moved past a first type of simulated spacing marker; and
imparting a second discrete haptic sensation, different from the first discrete haptic sensation, upon determining that the elongated flexible object has moved past a second type of simulated spacing marker.

24. The method of claim 18, further comprising:
determining the particular direction that the elongated flexible object has moved; and
imparting a discrete haptic sensation corresponding to the determined direction.

25. The method of claim 18, wherein the elongated flexible object is adapted to be contacted by the user, the method further comprising imparting the discrete haptic sensation to the user via the elongated flexible object.

26. The method of claim 25, wherein imparting the discrete haptic sensation includes imparting an active force to the elongated flexible object.

27. The method of claim 25, wherein imparting the discrete haptic sensation includes imparting a resistive force to the elongated flexible object.

28. The method of claim 18, wherein the elongated flexible object comprises at least one of a catheter or a scope adapted to be inserted into a patient.

29. The method of claim 18, wherein the elongated flexible object comprises a master controller in a master-slave surgical system.

30. The method of claim 18, further comprising enabling adjustment of at least one of a quality and quantity of imparted discrete haptic sensations during a surgical procedure.

31. The method of claim 18, further comprising defining the incremental distance during a surgical procedure.

32. The method of claim 18, further comprising enabling selective imparting of the discrete haptic sensation during the detecting.

33. The method of claim 18, further comprising displaying a graphical representation of the imparted discrete haptic sensations to the user.

34. The method of claim 20, wherein
the elongated flexible instrument includes catheter; and
the translational degree of freedom is an insertion of the catheter into a vascular organ of a patient's body.

35. The method of claim 34, wherein the discrete haptic sensations provide the user with discrete haptic indications of the amount of incremental insertion of the catheter into the length of the vascular organ.

36. A haptic metering system, comprising:
at least one input transducer adapted to detect motion of a surgical instrument within at least two degrees of freedom and output a signal corresponding to the detected motion, the surgical instrument adapted to be moved at least linearly and rotatably under control of a user;
control electronics adapted to receive the signal output by the at least one input transducer, repeatedly determine whether the surgical instrument has moved by a defined incremental distance in a particular direction with respect to a reference, and output a control signal each time it is determined that the surgical instrument has moved by the defined incremental distance in the particular direction; and
an output transducer adapted to receive the control signals and impart a discrete haptic sensation upon the user based upon each of the received control signals.

37. The system of claim 36, wherein a first of the two degrees of freedom is a translational degree of freedom for inserting or retracting the surgical instrument along the length of a tubular body organ and a second of the two degrees of freedom is a rotary degree of freedom for rotating the surgical instrument within the tubular body organ.

38. The system of claim 37, wherein the control electronics is further adapted to determine the degree of freedom within which the surgical instrument has moved and output a control signal corresponding to the degree of freedom within which the surgical instrument is determined to have moved.

39. The system of claim 36, wherein the control electronics is further adapted to determine the number of defined incremental distances that the surgical instrument has moved and output a control signal corresponding to the number of defined incremental distances the surgical instrument is determined to have moved.

40. The system of claim 36, wherein the control electronics is further adapted to determine the particular direction that the surgical instrument has moved and output a control signal corresponding to the direction the surgical instrument is determined to have moved.

41. The system of claim 36, wherein
the surgical instrument is adapted to be directly contacted by the user; and
the output transducer is adapted to impart the discrete haptic sensation to the user via the surgical instrument.

42. The system of claim 36, wherein the surgical instrument comprises at least one of a catheter or a scope adapted to be inserted into a patient.

43. The system of claim 36, wherein the surgical instrument comprises a master controller in a master-slave surgical system.

44. The system of claim 36, further comprising a user interface coupled to the control electronics, the user interface being adapted to enable adjustment of at least one of a quality and a quantity of the discrete haptic sensations imparted by the output transducer.

45. The system of claim 36, further comprising a user interface coupled to the control electronics, the user interface being adapted to enable the incremental distance to be adjustably defined.

46. The system of claim 36, further comprising a manually controllable element coupled to the control electronics, the manually controllable element being adapted to enable selective imparting of the discrete haptic sensations by the output transducer.

47. The system of claim 36, further comprising a visual display coupled to the control electronics, the visual display adapted to display a graphical representation of the discrete haptic sensations imparted by the output transducer.

48. A haptic metering system, comprising:
at least one input transducer adapted to detect linear motion of an elongated flexible object and output a signal corresponding to the detected linear motion, the elongated flexible object adapted to be moved under control of a user;
control electronics adapted to receive the signals output by the at least one input transducer, repeatedly determine whether the elongated flexible object has moved in a particular direction past one of a plurality of simulated spacing markers, and output a control signal when it is determined that the object has moved past a simulated spacing marker; and
an output transducer adapted to receive the control signals and impart a discrete haptic tick-mark sensation upon the user based on each of the received control signals.

49. The system of claim 48, wherein the at least one input transducer is further adapted to detect rotary motion of the elongated flexible object.

50. The system of claim 49, wherein the control electronics is further adapted to determine whether the detected motion of the elongated flexible object is linear or rotary and to output a control signal corresponding to the determined motion.

51. The system of claim 48, wherein
the control electronics is further adapted to determine whether the elongated flexible object has moved past a first type or a second type of the plurality of simulated spacing markers and output a control signal corresponding to the type of simulated spacing marker the elongated flexible object is determined to have moved past; and
the output transducer is further adapted to impart a first type of discrete haptic tick-mark sensation upon receiving a control signal corresponding to the first type of simulated spacing marker and to impart a second type of discrete haptic tick-mark sensation, different from the first type of discrete haptic tick-mark sensation, upon receiving a control signal corresponding to the second type of simulated spacing marker.

52. The system of claim 48, wherein
the control electronics is further adapted to determine whether the elongated flexible object has moved in a first direction or a second direction, opposite the first direction, and output a control signal corresponding to the direction the elongated flexible object is determined to have moved past; and
the output transducer is further adapted to impart a first type of discrete haptic tick-mark sensation upon receiving a control signal corresponding to the first direction and to impart a second type of discrete haptic tick-mark sensation, different from the first type of discrete haptic tick-mark sensation, upon receiving a control signal corresponding to the second direction.

53. The system of claim 48, wherein
the elongated flexible object is adapted to be directly contacted by the user; and
the output transducer is adapted to impart the discrete haptic tick-mark sensation to the user via the elongated flexible object.

54. The system of claim 48, wherein the elongated flexible object comprises at least one of a catheter or a scope adapted to be inserted into a patient.

55. The system of claim 48, wherein the elongated flexible object comprises a master controller in a master-slave surgical system.

56. The system of claim 48, further comprising a user interface coupled to the control electronics, the user interface being adapted to enable adjustment of at least one of a quality and a quantity of the discrete haptic tick-mark sensations imparted by the output transducer.

57. The system of claim 48, further comprising a user interface coupled to the control electronics, the user interface being adapted to enable adjustment of the simulated spacing marker.

58. The system of claim 48, further comprising a manually controllable element coupled to the control electronics, the manually controllable element being adapted to enable selective imparting of discrete haptic tick-mark sensations by the output transducer.

59. The system of claim 48, further comprising a visual display coupled to the control electronics, the visual display adapted to display a graphical representation of the discrete haptic tick-mark sensations imparted by the output transducer.
